(19) United States
(12) Patent Application Publication
(10) Pub. No.: US 2024/0322201 A1
(43) Pub. Date: Sep. 26, 2024

(54) ELECTROCHEMICAL CELL

(71) Applicant: DENSO CORPORATION, Kariya-city (JP)

(72) Inventors: Go IIJIMA, Kariya-city (JP); Junichi NARUSE, Kariya-city (JP); Kyohei USAMI, Kariya-city (JP)

(21) Appl. No.: 18/600,257

(22) Filed: Mar. 8, 2024

(30) Foreign Application Priority Data
Mar. 23, 2023 (JP) 2023-046828

(51) Int. Cl. H01M 8/04082; H01M 4/86

(52) U.S. Cl. CPC H01M 8/04216; H01M 4/8605; H01M 2300/0017

(57) ABSTRACT

An electrochemical cell includes a working electrode, a counter electrode, and an electrolyte covering the working electrode and the counter electrode. The working electrode and the counter electrode are configured so that, in response to a voltage applied between the working electrode and the counter electrode, electrons are supplied from the counter electrode to the working electrode, and the working electrode adsorbs CO₂ in association with the electrons being supplied. The counter electrode is not provided with an active material and is made of a porous material.

### CROSS REFERENCE TO RELATED APPLICATION

The present application claims the benefit of priority from Japanese Patent Application No. 2023-046828 filed on Mar. 23, 2023. The entire disclosure of the above application is incorporated herein by reference.

### TECHNICAL FIELD

The present disclosure relates to an electrochemical cell that adsorbs carbon dioxide.

### BACKGROUND

Conventionally, there has been known an electrochemical cell that recovers CO₂ from a mixed gas containing CO₂ by an electrochemical reaction.

### SUMMARY

The present disclosure provides an electrochemical cell including a working electrode, a counter electrode, and an electrolyte covering the working electrode and the counter electrode. The working electrode and the counter electrode are configured so that, in response to a voltage applied between the working electrode and the counter electrode, electrons are supplied from the counter electrode to the working electrode, and the working electrode adsorbs CO₂ in association with the electrons being supplied. The counter electrode is not provided with an active material and is made of a porous material.

### BRIEF DESCRIPTION OF DRAWINGS

Objects, features and advantages of the present disclosure will become apparent from the following detailed description made with reference to the accompanying drawings. In the drawings:

FIG. 1 is a diagram illustrating a carbon dioxide recovery system according to an embodiment of the present disclosure;

FIG. 2 is a diagram illustrating a carbon dioxide recovery device;

FIG. 3 is a cross-sectional view of an electrochemical cell;

FIG. 4A is a diagram for explaining the operation of the carbon dioxide recovery device in a CO₂ recovery mode;

FIG. 4B is a diagram for explaining the operation of the carbon dioxide recovery device in a CO₂ discharge mode; and

FIG. 5 is a diagram showing CO₂ adsorption capacities of electrochemical cells of Examples and Comparative Examples.

### DETAILED DESCRIPTION

Next, a relevant technology is described only for understanding the following embodiments. An electrochemical cell according to the relevant technology includes a working electrode including a CO₂ adsorbent, and a counter electrode including a counter electrode active material. The CO₂ adsorbent and the counter electrode active material are electroactive species made of organic materials. A potential difference between the working electrode and the counter electrode is changed, so that the CO₂ adsorbent can switch between adsorption and desorption of CO₂, and the counter electrode active material exchanges electrons with the CO₂ adsorbent.

However, when the electrochemical cell is operated in the presence of O₂ such as air, charge transfer to O₂ occurs, and superoxide O₂_{^{−}}, which is a kind of active oxygen, is generated at the working electrode. When O₂_{^{−}} generated at the working electrode diffuses to the counter electrode, the counter electrode active material made of an organic material is oxidatively decomposed by the active oxygen, and the amount of electrons supplied from the counter electrode to the working electrode decreases. As a result, a CO₂ adsorption amount of the working electrode decreases.

According to an aspect of the present disclosure, an electrochemical cell for adsorbing and desorbing CO₂ from a gas containing CO₂ by electrochemical reactions is provided. The electrochemical cell includes a working electrode, a counter electrode, and an electrolyte covering the working electrode and the counter electrode. The working electrode and the counter electrode are configured so that, in response to a voltage applied between the working electrode and the counter electrode, electrons are supplied from the counter electrode to the working electrode, and the working electrode adsorbs CO₂ in association with the electrons being supplied. The counter electrode is not provided with an active material and is made of a porous material.

In the above-described electrochemical cell, even when O₂_{^{−}} is generated from O₂ contained in the CO₂ containing gas at the working electrode and O₂_{^{−}} reaches the counter electrode, there is no counter electrode active material that is to be oxidatively decomposed. Therefore, a decrease in CO₂ adsorption amount of the electrochemical cell due to oxidative decomposition of a counter electrode active material can be restricted.

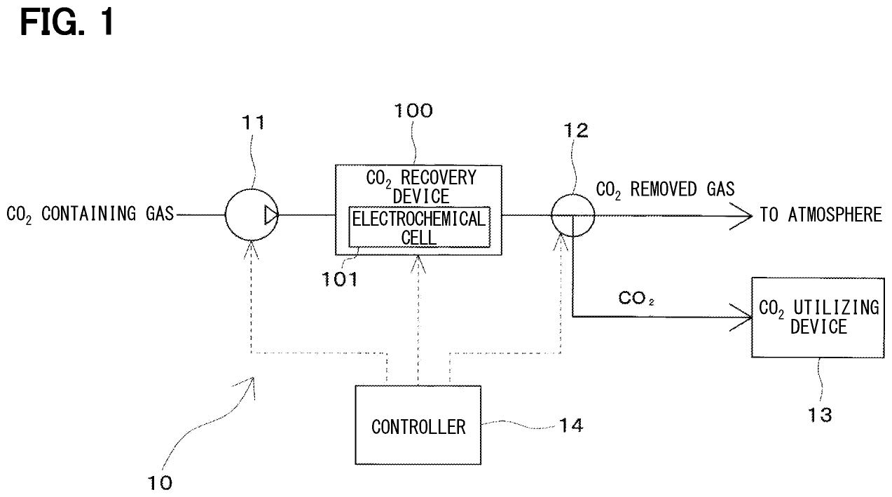

An embodiment of the present disclosure will be described below with reference to the drawings. As shown in FIG. 1, a carbon dioxide recovery system 10 of the present embodiment includes a compressor 11, a carbon dioxide recovery device 100, a passage switching valve 12, a carbon dioxide utilizing device 13, and a controller 14.

The compressor 11 pumps a CO₂ containing gas to the carbon dioxide recovery device 100. The CO₂ containing gas is a mixed gas containing CO₂ and a gas other than CO₂. For example, the atmosphere or exhaust gas of an internal combustion engine can be used as the CO₂ containing gas. The CO₂ containing gas contains at least O₂ as the gas other than CO₂.

The carbon dioxide recovery device 100 is a device that separates and recovers CO₂ from the CO₂ containing gas. The carbon dioxide recovery device 100 discharges a CO₂ removed gas that is gas after CO₂ is recovered from the CO₂ containing gas, or CO₂ recovered from the CO₂ containing gas. The configuration of the carbon dioxide recovery device 100 will be described in detail later.

The passage switching valve 12 is a three-way valve that switches a passage of exhaust gas from the carbon dioxide recovery device 100. The passage switching valve 12 switches the passage of the exhaust gas toward the atmosphere when the CO₂ removed gas is discharged from the carbon dioxide recovery device 100, and switches the passage of the exhaust gas toward the carbon dioxide utilizing device 13 when CO₂ is discharged from the carbon dioxide recovery device 100.

The carbon dioxide utilizing device 13 is a device that utilizes CO₂. The carbon dioxide utilizing device 13 may be a storage tank for storing CO₂ or a conversion device for converting CO₂ into fuel. As the conversion device, a device that converts CO₂ into a hydrocarbon fuel such as methane can be used. The hydrocarbon fuel may be gaseous fuel at normal temperature and pressure, or may be liquid fuel at normal temperature and pressure.

The controller 14 includes a well-known microcontroller including a central processing device (CPU), a read only memory (ROM), a random access memory (RAM) and the like, and peripheral circuits thereof. The controller 14 performs various calculations and processes based on control programs stored in the ROM, and controls actuations of various devices connected to an output side of the controller 14. The controller 14 of the present embodiment performs an operation control of the compressor 11, an operation control of the carbon dioxide recovery device 100, a passage switching control of the passage switching valve 12 and the like.

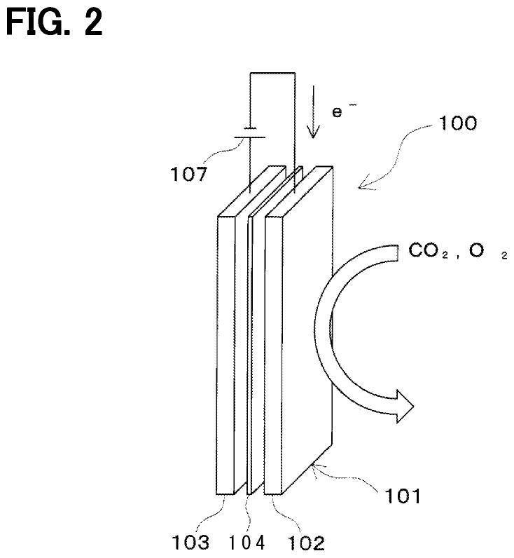

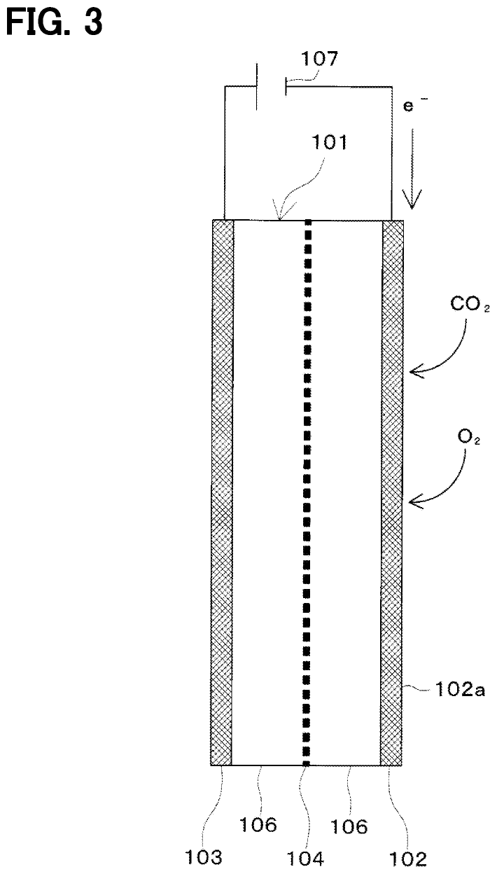

Next, the carbon dioxide recovery device 100 will be described with reference to FIG. 2 and FIG. 3. As shown in FIG. 2, the carbon dioxide recovery device 100 includes an electrochemical cell 101 configured to adsorb and desorb CO₂ by electrochemical reactions. The electrochemical cell 101 includes a working electrode 102, a counter electrode 103 and an insulating layer 104. In the example shown in FIG. 2, the working electrode 102, the counter electrode 103 and the insulating layer 104 are each formed in a plate shape. In FIG. 2, the working electrode 102, the counter electrode 103 and the insulating layer 104 are illustrated to have a distance therebetween, but actually, these components are arranged to be in contact with each other via an electrolyte 106 as shown in FIG. 3.

The electrochemical cell 101 may be housed in a container (not shown). The container may define a gas inlet for introducing the CO₂ containing gas into the container and a gas outlet for discharging the CO₂ removed gas and CO₂ out of the container.

The carbon dioxide recovery device 100 is configured to adsorb and desorb CO₂ by the electrochemical reactions of the electrochemical cell 101, thereby separating and recovering CO₂ from the CO₂ containing gas. The carbon dioxide recovery device 100 includes a power supply 107 that applies a predetermined voltage to the working electrode 102 and the counter electrode 103, and can change a potential difference between the working electrode 102 and the counter electrode 103. The working electrode 102 is a negative electrode, and the counter electrode 103 is a positive electrode.

The electrochemical cell 101 can be switched between a CO₂ recovery mode in which CO₂ is recovered at the working electrode 102 and a CO₂ discharge mode in which CO₂ is discharged from the working electrode 102 by changing the potential difference between the working electrode 102 and the counter electrode 103. The CO₂ recovery mode is a charging mode for charging the electrochemical cell 101, and the CO₂ discharge mode is a discharging mode for discharging the electrochemical cell 101.

In the CO₂ recovery mode, a first voltage V1 is applied between the working electrode 102 and the counter electrode 103, and electrons flows from the counter electrode 103 to the working electrode 102. At the first voltage V1, the counter electrode potential is greater than the working electrode potential. The first voltage V1 may fall within the range from 0.5 to 2.0 V.

In the CO₂ discharge mode, a second voltage V2 is applied between the working electrode 102 and the counter electrode 103, and electrons flows from the working electrode 102 to the counter electrode 103. The second voltage V2 is different from the first voltage V1. The second voltage V2 is a voltage lower than the first voltage V1, and a magnitude relationship between the working electrode potential and the counter electrode potential is not limited. That is, in the CO₂ discharge mode, the working electrode potential may be lower than, equal to, or greater than the counter electrode potential.

In the electrochemical cell 101 of the present embodiment, when a voltage is applied between the working electrode 102 and the counter electrode 103, an electric double layer is formed by electrons and ions contained in an electrolyte 106. In the CO₂ recovery mode, when cations of the electrolyte 106 move to the vicinity of the working electrode 102 and anions of the electrolyte 106 move to the vicinity of the counter electrode 103, a potential difference is formed between the vicinity of the respective surfaces, and electrons are supplied from the counter electrode 103 to the working electrode 102. In the CO₂ discharge mode, anions of the electrolyte 106 move to the vicinity of the working electrode 102, cations of the electrolyte 106 move to the vicinity of the counter electrode 103, and electrons are supplied from the working electrode 102 to the counter electrode 103.

In the present embodiment, a porous material is used as an electrode material constituting each of the working electrode 102 and the counter electrode 103. The porous material used for each of the working electrode 102 and the counter electrode 103 has a large number of pores through which the CO₂ containing gas can pass. As the porous material, a metal material or a carbon material can be used. The porous material can have a pore size of, for example, 0.1 to 1.0 mm.

As the metal porous body constituting each of the working electrode 102 and the counter electrode 103, for example, a foam mesh obtained by forming a metal into a mesh shape can be used. A sintered metal can be used as the metal porous body. As the metal material constituting the working electrode 102, any metal can be used, and for example, stainless steel (SUS) can be used.

Stainless steel is an alloy containing a plurality of types of metals, and an oxide film is formed on a surface thereof. The stainless steel is an alloy steel containing iron as a main component, 1.2% or less of carbon, and 10.5% or more of chromium. Any type of stainless steel can be used for the working electrode 102.

A stainless steel porous body used in the present embodiment has a cell density of 20 to 80 ppi (pixels per inch), an average pore size of 0.16 to 0.51 mm, and an average porosity of 84 to 94%. The cell density means the area of metal present per square inch.

The carbon material constituting each of the working electrode 102 and the counter electrode 103 may be, for example, carbon paper, carbon cloth, non-woven carbon mat, porous gas diffusion layer (GDL) and the like.

The working electrode 102 and the counter electrode 103 of the present embodiment are not provided with an active material that gives and receives electrons by an oxidation-reduction reaction. In the working electrode 102, the porous material used as the electrode material functions as a CO₂ adsorbent.

The insulating layer 104 is disposed between the working electrode 102 and the counter electrode 103, and separates the working electrode 102 and the counter electrode 103 from each other. The insulating layer 104 is an insulating ion permeable membrane that prevents physical contact between the working electrode 102 and the counter electrode 103 to restrict an electrical short circuit and that allows ions to permeate therethrough.

As the insulating layer 104, a separator or a gas layer such as air can be used. In the present embodiment, a porous separator is used as the insulating layer 104. As the material of the separator, a cellulose membrane, a polymer, a composite material of a polymer and a ceramic, or the like can be used.

The electrolyte 106 having ionic conductivity is disposed between the working electrode 102 and the counter electrode 103. The electrolyte 106 is disposed between the working electrode 102 and the counter electrode 103 via the insulating layer 104. The electrolyte 106 covers the working electrode 102, the counter electrode 103 and the insulating layer 104.

Any electrolyte material can be used as the electrolyte 106. In the present embodiment, an aprotic electrolyte is used as the electrolyte 106. The aprotic electrolyte is an electrolyte that does not donate protons (H⁺). Therefore, charges do not move to the electrolyte 106 due to proton generation, and a decrease in current efficiency during CO₂ adsorption can be restricted.

An ionic liquid can be used as the electrolyte 106 having an aprotic property. The ionic liquid is a salt of a liquid having non-volatility under normal temperature and pressure. When the ionic liquid is used as the electrolyte 106, the ionic liquid may be gelled to prevent elution of the ionic liquid from the electrochemical cell 101. As the ionic liquid having an aprotic property, [BMIM][TFSI], [TMPA][TFSI], [Pyrro][TFSI], [BMIM][Tfb], [EMIM][TFSI], or the like can be used.

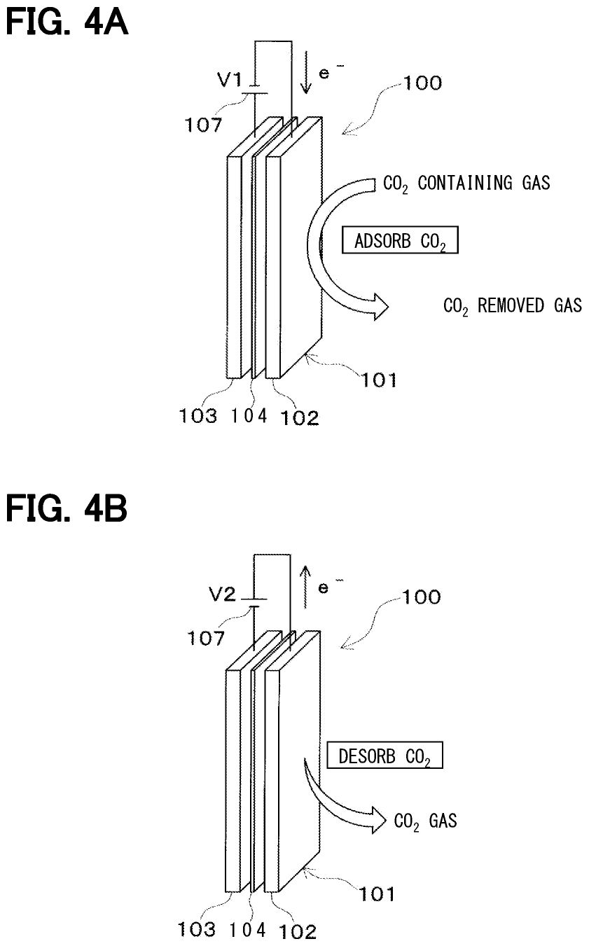

Next, an operation of the carbon dioxide recovery system 10 of the present embodiment will be described. The carbon dioxide recovery system 10 operates by alternately switching between the CO₂ recovery mode shown in FIG. 4A and the CO₂ discharge mode shown in FIG. 4B. The operation of the carbon dioxide recovery system 10 is controlled by the controller 14.

First, the CO₂ recovery mode will be described. In the CO₂ recovery mode, the compressor 11 operates to supply the CO₂ containing gas to the carbon dioxide recovery device 100. In the carbon dioxide recovery device 100, the voltage applied between the working electrode 102 and the counter electrode 103 is the first voltage V1.

When the first voltage V1 is applied between the working electrode 102 and the counter electrode 103, electrons are supplied from the counter electrode 103 to the working electrode 102, cations of the electrolyte 106 move to the vicinity of the working electrode 102, and the electric double layer is formed. This makes it possible to simultaneously realize electron donation of the counter electrode 103 and electron attraction of the working electrode 102.

At the working electrode 102, O₂ contained in the CO₂ containing gas receives electrons and is reduced, thereby causing an oxygen reduction reaction. Superoxide O₂_{^{−}}, which is a type of active oxygen is formed by the oxygen reduction reaction. In the present embodiment, the working electrode 102 and the counter electrode 103 are not provided with a working electrode active material (for example, polyanthraquinone) made of an organic material. Therefore, even when O₂_{^{−}} is generated in the working electrode 102, there is no working electrode active material that is to be decomposed. In addition, even when O₂_{^{−}} generated at the working electrode 102 diffuses to the counter electrode 103 through the electrolyte 106, there is no counter electrode active material that is to be decomposed.

The working electrode 102 that has received the electrons adsorbs CO₂ contained in the CO₂ containing gas. Thus, the carbon dioxide recovery device 100 can recover CO₂ from the CO₂ containing gas.

After CO₂ is recovered from the CO₂ containing gas by the carbon dioxide recovery device 100, the CO₂ containing gas is discharged from the carbon dioxide recovery device 100 as the CO₂ removed gas containing no CO₂. The passage switching valve 12 switches the passage of exhaust gas toward the atmosphere, and the CO₂ removed gas from the carbon dioxide recovery device 100 is discharged to the atmosphere.

Next, the CO₂ discharge mode will be described. In the CO₂ discharge mode, the operation of the compressor 11 is stopped, and the supply of the CO₂ containing gas to the carbon dioxide recovery device 100 is stopped. In the carbon dioxide recovery device 100, the voltage applied between the working electrode 102 and the counter electrode 103 is the second voltage V2.

In the CO₂ discharge mode, anions of the electrolyte 106 move to the surface of the working electrode 102, cations of the electrolyte 106 move to the vicinity of the counter electrode 103, and electrons are supplied from the working electrode 102 to the counter electrode 103. This makes it possible to simultaneously realize electron donation of the working electrode 102 and electron attraction of the counter electrode 103.

The working electrode 102 discharges electrons and desorbs CO₂. The CO₂ discharged from the working electrode 102 is discharged from the carbon dioxide recovery device 100. The passage switching valve 12 switches the passage of the exhaust gas toward the carbon dioxide utilizing device 13, and the CO₂ discharged from the carbon dioxide recovery device 100 is supplied to the carbon dioxide utilizing device 13.

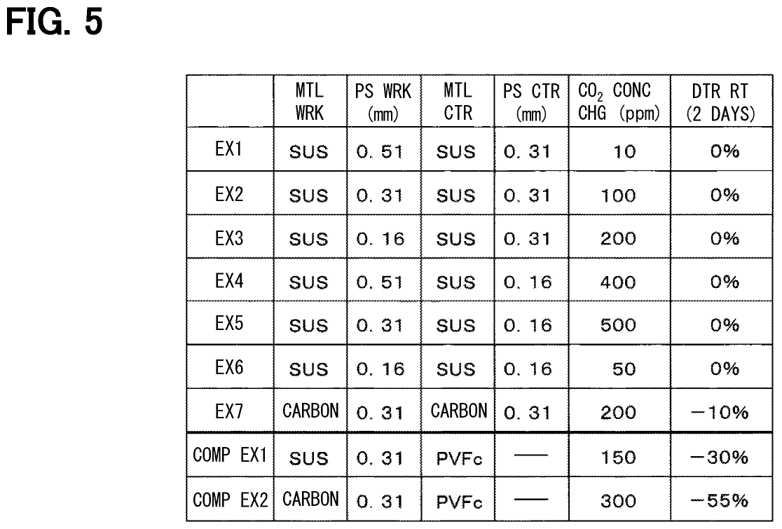

Next, the CO₂ adsorption amount and durability of the electrochemical cell 101 of the present embodiment will be described with reference to FIG. 5. FIG. 5 shows a material of the working electrode 102 (MTL WRK), a pore size of the working electrode 102 (PS WRK), a material of the counter electrode 103 (MTL CTR), a pore size of the counter electrode 103 (PS CTR), a CO₂ concentration change (CO₂ CONC CHG), and a deterioration rate (DTR RT) of each of Examples (EX) 1 to 7 and Comparative Examples (COMP EX) 1 and 2. As shown in FIG. 5, as the porous material constituting each of the working electrode 102 and the counter electrode 103, stainless steel (SUS) was used in Examples 1 to 6, and a carbon material was used in Example 7. In Examples 1 to 6, the pore size of the stainless steel used for each of the working electrode 102 and the counter electrode 103 was varied within a range from 0.16 to 0.51 mm. In Example 7, the pore size of the carbon material used for each of the working electrode 102 and the counter electrode 103 was 0.31 mm.

In Comparative Examples 1 and 2 shown in FIG. 5, the counter electrode 103 is provided with a counter electrode active material in addition to an electrode base material made of a metal material, a carbon material, or the like. The counter electrode active material is a material that gives and receives electrons by an oxidation-reduction reaction in the counter electrode 103. In Comparative Examples 1 and 2, polyvinyl ferrocene (PVFc), which is an organic material, was used as the counter electrode active material. In Comparative Example 1, stainless steel was used as the porous material constituting the working electrode 102. In Comparative Example 2, a carbon material was used as the porous material constituting the working electrode 102. In Comparative Examples 1 and 2, the pore size of the porous material used for the working electrode 102 was 0.31 mm.

The CO₂ concentration change in FIG. 5 is a result of measuring the CO₂ concentration change of the CO₂ containing gas before and after the CO₂ adsorption in a case where the CO₂ adsorption in the electrochemical cell 101 is performed with a swing potential width of 2.5 V for 1800 seconds. The larger the numerical value of the CO₂ concentration change is, the larger the CO₂ adsorption amount in the working electrode 102 is.

As shown in FIG. 5, in Examples 1 to 7 in which the porous material was used for each of the working electrode 102 and the counter electrode 103, CO₂ adsorption capacities substantially equivalent to those of Comparative Examples 1 and 2 in which the counter electrode active material was used were obtained. In particular, in Examples 4 and 5, CO₂ adsorption capacities higher than those of Comparative Examples 1 and 2 were obtained.

The deterioration rate in FIG. 5 is a change rate of the CO₂ adsorption amount of the working electrode 102 after the CO₂ adsorption in the electrochemical cell 101 is performed for two days, and indicates the durability of the electrochemical cell 101. When the deterioration rate is negative, it indicates that the CO₂ adsorption amount decreases and the CO₂ adsorption capacity decreases.

As shown in FIG. 5, the deterioration rate of Comparative Example 1 is −30%, and the deterioration rate of Comparative Example 2 is −55%. Thus, the CO2 adsorption capacities of the Comparative Examples 1 and 2 were significantly reduced. It is considered that this is because O₂_{^{−}} generated at the working electrode 102 was diffused to the counter electrode 103 by continuously operating the electrochemical cell 101, and the counter electrode active material made of the organic material was decomposed. Furthermore, it is considered that this is also caused by decomposition of the working electrode active material made of the organic material by O₂_{^{−}} generated in the working electrode 102.

On the other hand, in Examples 1 to 6, the deterioration rates were 0%, and in Example 7, the deterioration rate was −10%. In Examples 1 to 7, since the counter electrode active material was not used, it is considered that even if O₂_{^{−}} was generated at the working electrode 102, the decrease in the CO₂ adsorption amount due to the decomposition of a counter electrode active material could be restricted.

In the present embodiment described above, the counter electrode 103 is not provided with a counter electrode active material, and the porous material is used as the electrode material for the counter electrode 103. Thus, even when O₂_{^{−}} is generated from O₂ contained in the CO₂ containing gas at the working electrode 102 and O₂_{^{−}} reaches the counter electrode 103, there is no counter electrode active material that is to be oxidatively decomposed. Therefore, it is possible to restrict the decrease in the CO₂ adsorption amount of the electrochemical cell 101 due to oxidative decomposition of a counter electrode active material.

In the present embodiment, the working electrode 102 is not provided with a working electrode active material, and the porous material is used as the electrode material for the working electrode 102. Thus, even when O₂_{^{−}} is generated from O₂ contained in the CO₂ containing gas at the working electrode 102, there is no working electrode active material that is to be oxidatively decomposed. Therefore, it is possible to restrict the decrease in the CO₂ adsorption amount of the electrochemical cell 101 due to oxidative decomposition of a working electrode active material.

In the present embodiment, an aprotic electrolyte is used as the electrolyte 106. Therefore, charges do not move to the electrolyte 106 due to proton generation, and the decrease in the current efficiency during CO₂ adsorption can be restricted.

The present disclosure is not limited to the above-described embodiment, and various modifications can be made without departing from the spirit of the present disclosure.

For example, in the above-described embodiment, an example in which the active material is not provided and the porous material is used as the electrode material for each of the working electrode 102 and the counter electrode 103 has been described. However, the electrochemical cell 101 may have a configuration in which at least in the counter electrode 103, an active material is not provided and the porous material is used as the electrode material. In other words, the working electrode 102 may be provided with a CO₂ adsorbent such as polyanthraquinone.

What is claimed is:

1. An electrochemical cell for adsorbing and desorbing CO₂ from a gas containing CO₂ by electrochemical reactions, comprising:
a working electrode;
a counter electrode; and
an electrolyte covering the working electrode and the counter electrode, wherein
the working electrode and the counter electrode are configured so that, in response to a voltage applied between the working electrode and the counter electrode, electrons are supplied from the counter electrode to the working electrode, and the working electrode adsorbs CO₂ in association with the electrons being supplied, and
the counter electrode is not provided with an active material and is made of a porous material.

2. The electrochemical cell according to claim 1, wherein the working electrode is not provided with an active material and is made of a porous material.

3. The electrochemical cell according to claim 1, wherein the porous material is stainless steel.

4. The electrochemical cell according to claim 1, wherein the porous material is a carbon material.

5. The electrochemical cell according to claim 1, wherein the electrolyte is an aprotic electrolyte.

6. The electrochemical cell according to claim 5, wherein the aprotic electrolyte is at least one ionic liquid selected from a group consisting of [BMIM][TFSI], [TMPA][TFSI], [Pyrro][TFSI], [BMIM][Tfb], and [EMIM][TFSI].
